(19) United States
(12) Patent Application Publication
(10) Pub. No.: US 2025/0150257 A1
(43) Pub. Date: May 8, 2025

(54) SECURE DISTRIBUTED PRIVATE DATA STORAGE SYSTEMS

(71) Applicant: Anzen Technology Systems Limited, Brighton, East Sussex (GB)

(72) Inventors: Hoon-Ywen Li, London (GB); Charlie Sillitoe Brown, Carnforth (GB); Achim D. Brucker, Exeter (GB)

(21) Appl. No.: 18/833,775

(22) PCT Filed: Jan. 19, 2023
(86) PCT No.: PCT/EP2023/051283

§ 371 Date: Jul. 26, 2024

(30) Foreign Application Priority Data
Jan. 27, 2022 (GB) 2201068.0

(51) Int. Cl. H04L 9/06; G06F 21/64

(52) U.S. Cl. CPC H04L 9/0656; G06F 21/64; H04L 9/0643

(57) ABSTRACT

A computer implemented method of securely storing an anonymised input data item, the method including: (i) obtaining a first set of data points defining a representation of the input data item, wherein each data point is defined by a numeric value; (ii) generating a plurality n of random or pseudorandom second sets of data points, where n is two or more, each set including a one-time-pad, (iii) encrypting the first set of data points n times using the n one-time-pads; and (iv) storing each of the n one-time-pads and the encrypted first set of data points at respective different locations.

### FIELD

This specification relates to methods and systems for secure, anonymised storage of private information in the cloud without contravention of territorial privacy laws.

### BACKGROUND

Legal requirements for protection of personal data mean that in many countries restrictions are imposed on where such information can be stored. Even if the content is encrypted many data protection laws prevent such information from being transferred out of the country, and the risk of increasingly advanced algorithms or leakage of passwords or encryption keys means that information may ultimately be leaked and become accessible. Further, cloud storage and processing providers typically may distribute or migrate content across multiple geographic sites as a form or redundancy or to assist with load balancing. Even if personal content is uploaded to a cloud in a local territory, backups may be made to other clouds throughout the world.

Background technology is described in U.S. Pat. Nos. 9,202,085 and 10,608,813.

There is a general need for increasing data security whilst retaining data sovereignty.

### SUMMARY

This specification generally relates to systems for securing, anonymising or pseudo-anonymising input data, in particular personal information, so that information can more easily be stored remotely e.g. whilst still meeting requirements for protection of personal data. The systems may be implemented by one or more computers in one or more locations.

In general terms, input data is encrypted a plurality of times by a plurality of unique, random or pseudorandom one-time-pads, which may be the same length or different lengths whereby each one-time-pad is used only once and not re-used. After the encryption process is complete, the user is left with the plurality of independently random one-time-pads and the cipher text which, to an attacker, are indistinguishable from each other as each appears to the attacker to effectively be independently random or pseudorandom data. The one-time-pads and the cipher text which are indistinguishable from each other (collectively described as data shards) are then stored. They may be stored separately from each other at different locations, for example in geographically separated data centres. Alternatively or additionally one or more non-overlapping, interleaving data shards and one time pads may be stored at the same location, for example in one data centre. To decrypt the cipher text the attacker first has to obtain control of all of the data shards which is difficult to do if they are controlled by different data centres at different locations. He must then determine which data shard is the cipher text and which are the one-time-pads and then decrypt the cipher text in the correct sequential order. Again, this impossible to do without access to all of the shards as they are independently random of each other and no amount of analysis allows the attacker to obtain any information that would allow him to identify which is which. Thus, as none of the data shards can be decrypted on their own and information about the original input cannot be obtained or inferred without control of all the shards (specifically if n is the total number of shards, anyone who controls n-1 shards or data centres in which the shard is stored cannot obtain or infer the original input), storing individual shards outside of the territory from where it originated is still able to comply with local data protection requirements intended to prevent private data being stored outside of the territory. To invalidate any shards that are known to have been compromised, re-encryption of the shards may be performed.

In the above referred to background technology of U.S. Pat. No. 10,608,813, encryption is performed with a plurality of derived data pads that are all derived from one or more random or pseudorandom base data pads that are re-used. The one or more base data pads in U.S. Pat. No. 10,608,813 facilitate the bulk generation of a very large number of derived data pads to deal with large amounts of data, for example one thousand derived data pads for each petabyte of data. However, the re-use of base data pads to generate a large number of derived data pads for large amounts of data results in a flawed, insecure system. Specifically there is a security weakness as the lack of independent randomness or pseudo-randomness in every derived data pad allows an attacker to infer information about the base data pads that are used from only a small number of the derived data pads. Thus, the attacker needs only to compromise a small number of storage locations to be able to successfully attack the scheme. This type of attack vector is particularly weak to an attacker using quantum attack methods to derive information about the base data pads and as such U.S. Pat. No. 10,608,813 is not quantum secure. In contrast, in the present disclosure, the one-time-pads used for the encryption steps are all independently random or pseudorandom of each other and are not derived from one or more re-usable base data pads. As a result, the method of the present disclosure is more secure than the known methods of U.S. Pat. No. 10,608,813 at a fundamental level, and, in particular, is quantum secure.

Accordingly, one aspect of the present disclosure relates to a system configured for securely storing an anonymised or pseudo-anonymised input data item. The system may include one or more hardware processors configured by machine-readable instructions. The processor(s) may be configured to obtain a first set of data points defining a representation of the input data item. Each data point may be defined by a numeric value. The processor(s) may be configured to generate a plurality n of independently random or pseudorandom second sets of data points each set including a one-time-pad, where n is two or more. The processor(s) may be configured to encrypt the first set of data points n times, each time using only one of the n one-time-pads, thereby ensuring no security weakness is introduced into the system through the re-use of any one-time pad in any way. The processor(s) may be configured to store each of the n one-time-pads and the encrypted first set of data points at respective different locations. Thus, the total number of data shards stored across different locations is n+1 (that is, n one-time-pads plus one set of (now encrypted) first data points whereby this one set of first data points is the output of the final one-time-pad operation and is indistinguishable from the n one-time-pads so that any data centre operator storing the shards in a data centre does not know and cannot determine if they are storing a one-time-pad or the encrypted data points. For example, in one implementation, there may be three data shards in total, whereby two are the one-time-pads and one is the first data points. In other implementations, n may be more, for example where the total number of data shards is three, four, five, six, seven, eight, or more.

In some implementations, the first set of data points and each of the second sets of data points has the same bit length.

Advantageously, this ensures it is not possible for an attacker to distinguish between the first set of data points and each of the second sets of data points. This is because, to the attacker, both the first set of data points and each of the second sets of data points appear as a truly random set of data given the independent randomness of the second sets of data points. As such, no amount of analysis of any compromised shards allows the attacker to identify which set of data points is which, unless he obtains the first set of data points and all of the second sets of data points, which is difficult to do if they are each stored at separate locations. The term independent randomness as used herein and as will be described in further detail below means, in general terms, randomness generated using, for example, a cryptographically secure random or pseudo random number generator implemented in software or in hardware devices that provide this functionality. It is envisaged that this may include quantum random generators.

In some implementations of the system, the different locations may include geographically separated data centres and wherein the storing includes storing the n one-time-pads on one or more servers at the geographically separated data centres.

In some implementations, each of the n one-time-pads and the encrypted first set of data points, i.e. the output of the final one-time-pad operation that is indistinguishable from the n one-time-pads, are stored in said respective different locations without being further encrypted.

Advantageously, as each of the n one-time-pads acts as an independent source of randomness or pseudo-randomness that is not re-used and thus which cannot be used to infer information about each other, there is no need to provide additional security to the storage of each of the n one-time-pads at their storage locations. For example, there is no need to further encrypt the n one-time-pads as would typically be expected in traditional systems where access to one of the one-time-pads would compromise security of the system. As a result, implementing the present system is easier as there is no need implement additional encryption or security during storage of the n one-time-pads (and/or the indistinguishable encrypted first set of data points).

In some implementations of the system, the processor(s) are configured to encode the input data item according to a predetermined encoding protocol to generate said representation of the input data item. For example, the input data item may be encrypted or transcoded in a pre-processing step. This may be performed by the processor(s) and/or by an additional module of the system. It is envisaged that the pre-processing by the predetermined encoding protocol ensures that the input stream of data appears as a random stream of input data. This in turn improves security against any interception of the input data stream as an additional layer of encoding may be difficult to encode unless the attacker also has knowledge of the encoding protocol used.

In some implementations, the method may comprise splitting the input data item into a plurality of chunks before performing said encoding on each of said chunks according to said predetermined encoding protocol to generate said representation of the input data item.

In some implementations, the encoding and subsequent encrypting steps may be performed on each of said plurality of chunks at respective different locations, for example at a plurality of different servers at different geographic locations.

Advantageously, as described above, the input data item (for example a single piece of data or a stream of data) may be chunked (i.e. split) into data items each having the same bit length as part of the pre-processing encoding step. Each of these chunks May be sent to a different location for encrypting into a shard in the manner as described above. Not only does this allow data shard creation to occur in parallel at different locations for improved efficiency (i.e. each chunk processed at a different location ends up as a shard) but this improves security of the system prior to the encryption step. This is because even if an attacker compromises one location, he will only obtain access to one or only some of the chunks of the input data, rather than to the entire input data. In order to be able to obtain access to all the data, the attacker would have to compromise all of the locations at which the pre-processing occurs, something which is less likely for each additional location the system uses. This pre-processing encoding also allows the input data item to be checked for integrity and authenticity before it is encrypted which ensures corrupted and/or inauthentic data can be filtered out to avoid contaminating the data shards.

In some implementations, the splitting of the input data item comprises generating an index comprising an identifier for each chunk, and wherein the method comprises recording storage locations of the n one-time-pads and the encrypted first set of data points generated with each said chunk and associating the recorded storage locations with the identifier of the index. The sizes of the chunks can be fixed or can be dynamic and this may be configurable by setting a chunk size parameter according to the needs of a specific use case. For example, the chunk size parameter may be set based on the size of typical input files. For example the chunk size parameter may be set to result in increased chunk sizes where the input files are large video files or decreased chunk sizes where the input files are small snippets of metadata.

Advantageously, generating the index allows each chunk to be associated with its corresponding data shards and their storage location tracked. This facilitates partial retrieval, also called random access, of the input data item because if a user knows which chunk contains the data he wishes to retrieve, he simply has to request retrieval of the data shards generated using that chunk without needing to request all of the data shards associated with the entire input data item. For example, if the input data item is a large video file but the user only wishes to retrieve the video frames associated with a short clip of the video, the index may be used to locate the data shards associated with the chunks associated with the requested clip. The specific data shards can then be sent used to decrypt the data back into the chunk without needing to retrieve all the data shards associated with the whole large video file. This accordingly reduces the amount of data the present system requires during retrieval operations. This approach provides both a security and performance advantage.

From the performance advantage side, reducing the amount of data retrieved and communicated as part of retrieval operations reduces the overall bandwidth requirements of the system, thereby allowing the retrieval aspects of the system to be implemented using lower performance hardware, thereby reducing costs of the system.

From the security side, the more data that is communicated across the system, the more information that is in theory interceptable by any malicious actors operating on the communication channels used. Whilst this is not a risk from a purely cryptographic perspective given that they would not be able to decrypt the information unless all shards are compromised, they may seek to use social engineering or phishing attacks to compromise all shards. In this case, if they have already intercepted and stored huge volumes of data, there is a risk of a large data breach. In contrast, if only small chunks of data are being retrieved and communicated across communication channels for retrieval operations, the size of any data breach is likely to be substantially smaller as the total volume communicated is substantially smaller. This accordingly builds in an inherent risk reduction mechanism not provided by any known systems.

In some implementations, the method comprises storing the index at a storage location separate to the storage location at which the n one-time-pads and the encrypted first set of data points are stored.

Advantageously, this improves security as an attacker has to compromise a further location in order to be able to use the index.

In some implementations, the splitting the input data item into a plurality of chunks comprises setting a chunk size based on one or more of: (i) a past retrieval rate of the input data item, or (ii) a size of the input data item (for example a bit length).

Advantageously, if an input data item has a history of being retrieved frequently, it is envisaged that the system may split the input data item into smaller chunks to allow partial retrieval to be performed in the manner as described above but on more granular and smaller sized chunks. Thus a user is able to specify at a more granular level specifically which chunk of data he wishes to retrieve without needing to retrieve large parts of the data. This also increases the degree of parallelisation that is possible, making it easier to quickly and efficiently shard very large files. Conversely, where data is rarely retrieved, the system may increase the size of the chunks as the lower retrieval rate means it is unlikely any users will wish to request retrieval of the data at any level of granularity so there is no need to chunk the data into small chunk sizes prior to sharding.

In some implementations of the system, said encrypting comprises applying a linear function on the first set of data points using the n one-time-pads.

In some implementations of the system, the encrypting by applying a linear function may include applying n bit-wise XOR operations on the first set of data points using the n one-time-pads.

In some implementations of the system, the encrypting by applying a linear function may include applying n bit-wise modular additions on the first set of data points using the n one-time-pads.

In some implementations of the system, the first set of data points may have a predetermined bit length.

In some implementations of the system, each set of the plurality of second sets of data points may have the same bit length as the first set of data points.

In some implementations of the system, the processor(s) may be configured to retrieve, at predetermined intervals, from the plurality of different locations, the n one-time-pads and the encrypted first set of data points.

In some implementations of the system, the processor(s) may be configured to decrypt, at predetermined intervals, the encrypted first set of data points n times using the n one time pads.

In some implementations of the system, the processor(s) may be configured to perform, at predetermined intervals, steps to re-encrypt the first set of data points.

In some implementations of the system, the processor(s) may be configured to entropy scan the encrypted first set of data points.

In some implementations of the system, said entropy scanning is performed before storing the n one-time-pads and the encrypted first set of data points at the respective different locations.

In some implementations of the system, the processor(s) may be configured to apply a hash function to the encrypted first set of data points to generate a hash of the encrypted first set of data points; and apply a checksum function to the hash of the encrypted first set of data points to verify the integrity of the encrypted first set of data points.

In some implementations of the system, the processor(s) may be configured to apply a hash function to the first set of data points to generate a hash of the first set of data points; and apply a checksum function to the hash of the first set of data points to verify the integrity of the first set of data points.

In some implementations of the system, the hash of the first set of data points or the hash of the encrypted first set of data points comprises a message authentication code, MAC.

In some implementations of the system, the first set of data points comprises a numerical representation of a sequence of words and wherein the encrypted first set of data points comprises a cipher text.

In another aspect of the present disclosure, the above described system comprises a database management system for securely storing an anonymised data item, the database management system comprising a plurality a plurality of data stores for storing one or more data entries, and the above-described one or more processors a computer-readable medium connected to the processing device configured to store instructions that, when executed by the processing device, performs the operations of: (i) obtaining a first set of data points defining a representation of the input data item, wherein each data point is defined by a numeric value; (ii) generating a plurality n of random or pseudorandom second sets of data points, each set comprising a one-time-pad, (iii) encrypting the first set of data points n times using the n one-time-pads; and (iv) storing each of the n one-time-pads and the encrypted first set of data points at a respective one of the plurality of data stores.

In some implementations, the plurality of data stores are provided at geographically separated locations.

In some implementations, the plurality of data stores form a mesh network.

Another aspect of the present disclosure relates to a method for securely storing an anonymised input data item. The method may include obtaining a first set of data points defining a representation of the input data item. Each data point may be defined by a numeric value. The method may include generating a plurality n of random or pseudorandom second sets of data points each set including a one-time-pad. The method may include encrypting the first set of data points n times using the n one-time-pads. The method may include storing each of the n one-time-pads and the encrypted first set of data points at respective different locations.

In some implementations, the method further comprises performing the steps described in connection with the above-described system.

Yet another aspect of the present disclosure relates to a non-transient computer-readable storage medium having instructions embodied thereon, the instructions being executable by one or more processors to perform a method for securely storing an anonymised input data item. The method may include obtaining a first set of data points defining a representation of the input data item. Each data point may be defined by a numeric value. The method may include generating a plurality n of random or pseudorandom second sets of data points each set including a one-time-pad. The method may include encrypting the first set of data points n times using the n one-time-pads. The method may include storing each of the n one-time-pads and the encrypted first set of data points at respective different locations.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

Embodiments of the invention are described herein with reference to the attached drawings. It will be understood d that these embodiments are merely examples.

FIG. 1 illustrates a system configured for securely storing an anonymised input data item, in accordance with one or more implementations.

FIGS. 2A, 2B, 2C, 2D, and/or 2E illustrates a method for securely storing an anonymised input data item, in accordance with one or more implementations.

FIG. 3 illustrates a system configured for securely storing an anonymised input data item, in accordance with one or more implementations.

FIG. 4 illustratively shows a flowchart illustrating steps of a method according to the present disclosure.

### DETAILED DESCRIPTION

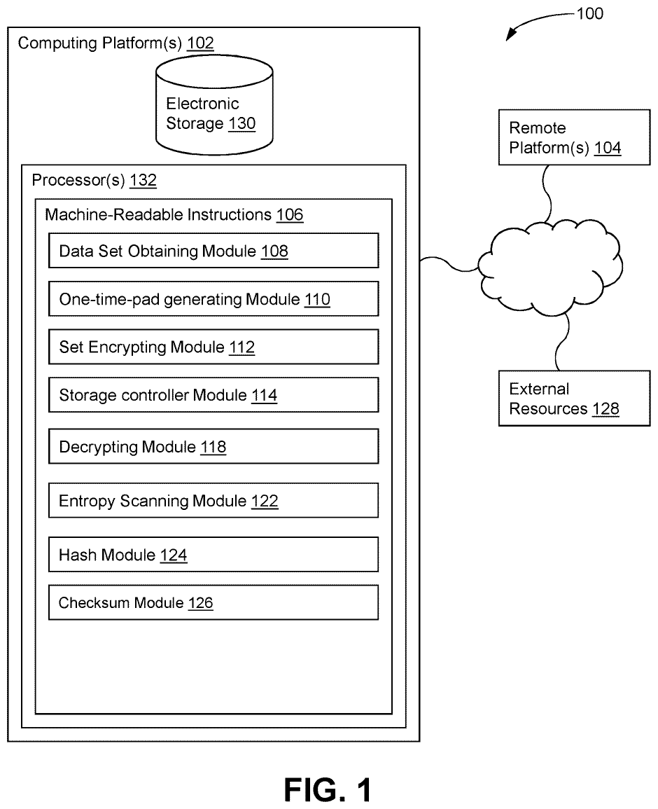

FIG. 1 illustrates a system 100 configured for securely storing an anonymised input data item, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of data set obtaining module 108, one-time-pad generating module 110, data set encrypting module 112, storage controller module 114, decrypting module 118, entropy scanning module 122, hash module 124, checksum module 126, and/or other instruction modules.

Data set obtaining module 108 may be configured to obtain a first set of data points defining a representation of the input data item. For example, the input data item may be encoded according to a predetermined encoding protocol to generate said representation of the input data item. This may comprise encrypting or transcoding the input data item during a pre-processing step. The first set of data points may have a predetermined bit length. Each set of the plurality of second sets of data points (described below) may have the same bit length as the first set of data points. The first set of data points may include a numerical representation of a sequence of words or any arbitrary data item, for example private or personal information.

One-time-pad generating module 110 may be configured to generate a plurality n of random or pseudorandom second sets of data points each set comprising a one-time-pad.

Data set encrypting module 112 may be configured to encrypt the first set of data points n times, each time using only one of the n one-time-pads, for example by applying a linear function to the first set of data points using the n one-time-pads. Using each independently random or pseudorandom one-time-pad only once ensures the system is not compromised by re-use of a one-time-pad in any way that would allow the attacker to infer information about the one-time-pad used. The linear function may comprise any linear operation over any field of the first set of data points. For example, the encrypting may comprise applying n bit-wise XOR operations on the first set of data points using the n one-time-pads. Alternatively, the encrypting may comprise applying n bit-wise modular additions or subtractions on the first set of data points using the n one-time-pads

Storage controller module 114 may be configured to store each of the n one-time-pads and the encrypted first set of data points at respective different locations. For example, by communicating through a network interface with one or more of the remote platforms 104 and/or external resources 128 at said respective different locations. The different locations may comprise geographically separated data centres and the remote platforms 104 and/or external resources 128 may comprise one or more servers at the geographically separated data centres. Additionally or alternatively, when processing occurs in “real time”, the data stream (i.e. a stream of input data items) may be multiplexed between different data centres. For example, one data centre could store the first m data sets of a one-time-pad followed by m′ data shards. Specifically, it is envisaged that any mapping to multiplex data streams may be used as long as one data centre does not store the same part of a one-time-pad and data stream.

The storage controller module 114 may further be configured to retrieve, at predetermined intervals, from the plurality of different locations the n one-time-pads and the encrypted first set of data points. As will be appreciated, the processing performed by the system may be performed in real time or near real time (i.e. online) as a stream of input data items or offline using pre-processing.

The decrypting module 118 may be configured to decrypt, at predetermined intervals, the retrieved encrypted first set of data points n times using the retrieved n one time pads. The decrypting may comprise applying any linear operation sequentially. For example, it may comprise applying n bit-wise xor operations on the encrypted first set of data points using the n one-time-pads. Alternatively, the decrypting may include applying n bit-wise modular subtractions or additions on the first set of data points using the n one-time-pads

The data set encrypting module 112 may be further configured to re-perform, at predetermined intervals, and/or upon detection of a security compromise, and/or upon request, the above-described encrypting steps to re-encrypt the first set of data points using a newly generated set of one-time-pads. As above, the encrypting may comprise applying n bit-wise xor operations on the first set of data points using the n one-time-pads. Alternatively, the encrypting may include applying n bit-wise modular additions or subtraction on the first set of data points using the n one-time-pads.

Entropy scanning module 122 may be configured to entropy scan the encrypted first set of data points. The entropy scanning may be performed before storing the n one-time-pads and the encrypted first set of data points at the respective different locations to ensure any hidden malware is not stored at the different locations embedded in encrypted first set of data points.

Hash module 124 may be configured to apply a hash function to the encrypted first set of data points to generate a hash of the encrypted first set of data points.

Hash module 124 may further be configured to apply a hash function to the first set of data points to generate a hash of the first set of data points. The hash of the first set of data points or the hash of the encrypted first set of data points may comprise or include a message authentication code mac.

Checksum module 126 may be configured to apply a checksum function to the hash of the encrypted first set of data points to verify the integrity of the encrypted first set of data points, or to the hash of the first set of data points to verify the integrity of the first set of data points.

In some implementations, computing platform(s) 102, remote platform(s) 104, and/or external resources 128 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 128 may be operatively linked via some other communication media.

A given remote platform 104 may include one or more processors configured to execute computer program modules. The computer program modules may be configured to enable an expert or user associated with the given remote platform 104 to interface with system 100 and/or external resources 128, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 128 may include sources of information outside of system 100, external entities participating with system 100, and/or other resources. In some implementations, some or all of the functionality attributed herein to external resources 128 may be provided by resources included in system 100.

Computing platform(s) 102 may include electronic storage 130, one or more processors 132, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 130 may comprise non-transitory storage media that electronically stores information. The electronic storage media of electronic storage 130 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 130 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 130 may include one or more virtual storage resources (e.g., cloud storage, a virtual private network, and/or other virtual storage resources). Electronic storage 130 may store software algorithms, information determined by processor(s) 132, information received from computing platform(s) 102, information received from remote platform(s) 104, and/or other information that enables computing platform(s) 102 to function as described herein.

Processor(s) 132 may be configured to provide information processing capabilities in computing platform(s) 102. As such, processor(s) 132 may include one or more of a digital processor, an analog processor, a digital circuit designed to process information, an analog circuit designed to process information, a state machine, and/or other mechanisms for electronically processing information. Although processor(s) 132 is shown in FIG. 1 as a single entity, this is for illustrative purposes only. In some implementations, processor(s) 132 may include a plurality of processing units. These processing units may be physically located within the same device, or processor(s) 132 may represent processing functionality of a plurality of devices operating in coordination. Processor(s) 132 may be configured to execute modules 108, 110, 112, 114, 116, 118, 120, 122, 124, and/or 126, and/or other modules. Processor(s) 132 may be configured to execute modules 108, 110, 112, 114, 116, 118, 120, 122, 124, and/or 126, and/or other modules by software; hardware; firmware; some combination of software, hardware, and/or firmware; and/or other mechanisms for configuring processing capabilities on processor(s) 132. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, and/or 126 are illustrated in FIG. 1 as being implemented within a single processing unit, in implementations in which processor(s) 132 includes multiple processing units, one or more of modules 108, 110, 112, 114, 116, 118, 120, 122, 124, and/or 126 may be implemented remotely from the other modules. The description of the functionality provided by the different modules 108, 110, 112, 114, 116, 118, 120, 122, 124, and/or 126 described below is for illustrative purposes, and is not intended to be limiting, as any of modules 108, 110, 112, 114, 116, 118, 120, 122, 124, and/or 126 may provide more or less functionality than is described. For example, one or more of modules 108, 110, 112, 114, 116, 118, 120, 122, 124, and/or 126 may be eliminated, and some or all of its functionality may be provided by other ones of modules 108, 110, 112, 114, 116, 118, 120, 122, 124, and/or 126. As another example, processor(s) 132 may be configured to execute one or more additional modules that may perform some or all of the functionality attributed below to one of modules 108, 110, 112, 114, 116, 118, 120, 122, 124, and/or 126.

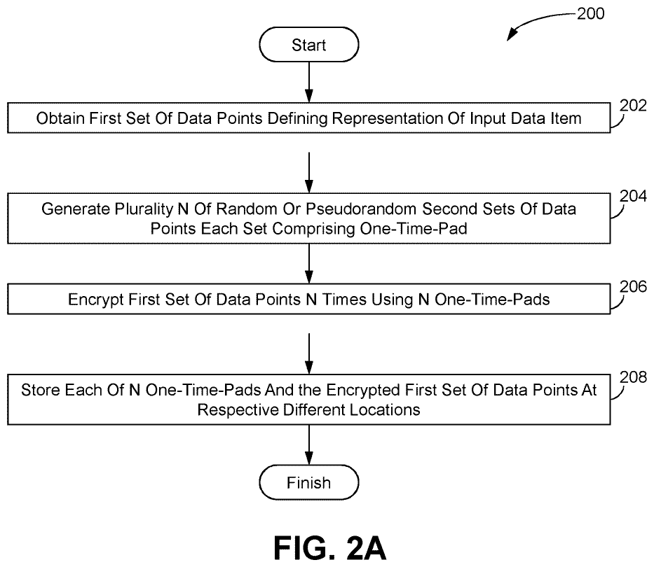

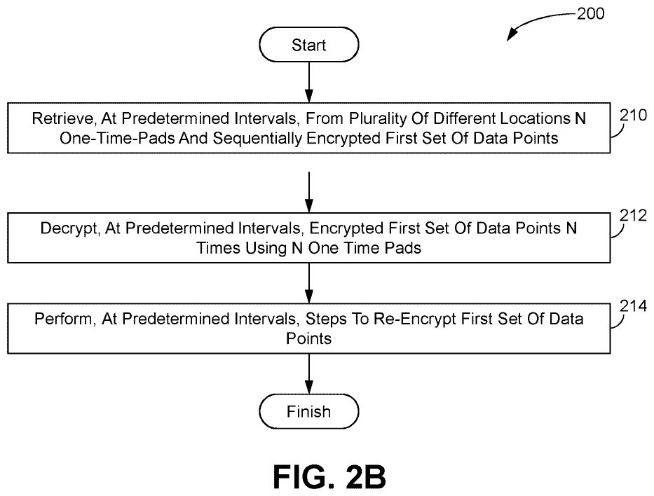

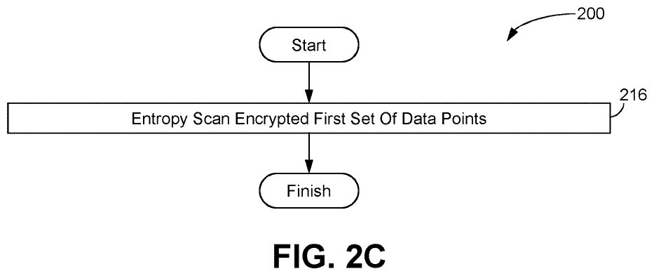

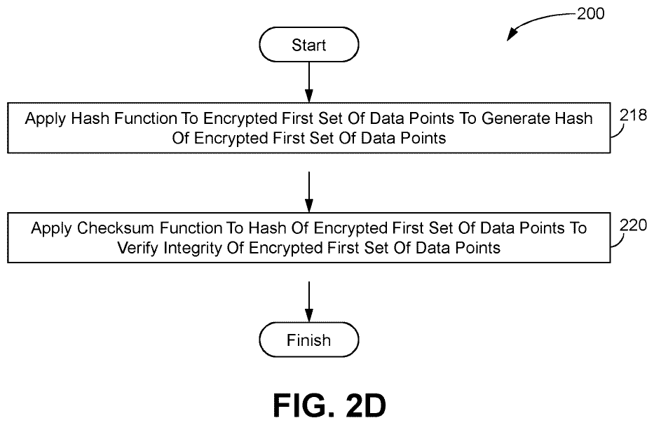

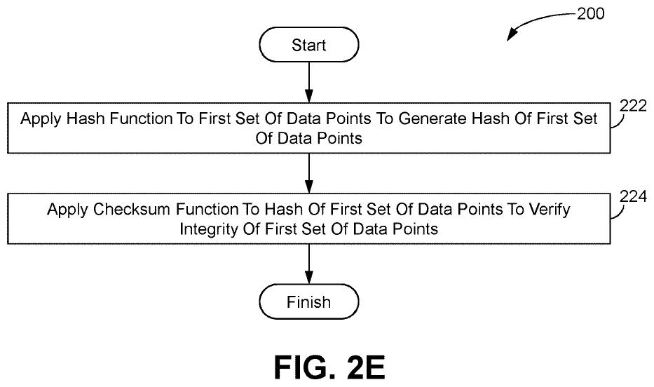

FIGS. 2A, 2B, 2C, 2D, and/or 2E illustrates a method 200 for securely storing an anonymised input data item, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIGS. 2A, 2B, 2C, 2D, and/or 2E and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

FIG. 2A illustrates method 200, in accordance with one or more implementations.

An operation 202 may include obtaining a first set of data points defining a representation of the input data item. Each data point may be defined by a numeric value. Operation 202 may be performed by one or more hardware processors configured by machine-readable instructions including a module that is the same as or similar to set obtaining module 108, in accordance with one or more implementations.

An operation 204 may include generating a plurality n of random or pseudorandom second sets of data points each set comprising a one-time-pad. Operation 204 may be performed by one or more hardware processors configured by machine-readable instructions including a module that is the same as or similar to one-time-pad generating module 110, in accordance with one or more implementations.

An operation 206 may include encrypting the first set of data points n times using the n one-time-pads. Operation 206 may be performed by one or more hardware processors configured by machine-readable instructions including a module that is the same as or similar to data set encrypting module 112, in accordance with one or more implementations.

An operation 208 may include storing each of the n one-time-pads and the encrypted first set of data points at respective different locations. Operation 208 may be performed by one or more hardware processors configured by machine-readable instructions including a module that is the same as or similar to storage controller module 114, in accordance with one or more implementations.

FIG. 2B illustrates method 200, in accordance with one or more implementations.

An operation 210 may include retrieving, at predetermined intervals, from the plurality of different locations the n one-time-pads and the encrypted first set of data points. Operation 210 may be performed by one or more hardware processors configured by machine-readable instructions including a module that is the same as or similar to storage controller module 114, in accordance with one or more implementations.

An operation 212 may include decrypting, at predetermined intervals, the encrypted first set of data points n times using the n one time pads. Operation 212 may be performed by one or more hardware processors configured by machine-readable instructions including a module that is the same as or similar to decrypting module 118, in accordance with one or more implementations.

An operation 214 may include performing, at predetermined intervals, steps to re-encrypt the first set of data points. Operation 214 may be performed by one or more hardware processors configured by machine-readable instructions including a module that is the same as or similar to data set encrypting module 112, in accordance with one or more implementations.

FIG. 2C illustrates method 200, in accordance with one or more implementations.

An operation 216 may include further including entropy scanning the encrypted first set of data points. Operation 216 may be performed by one or more hardware processors configured by machine-readable instructions including a module that is the same as or similar to entropy scanning module 122, in accordance with one or more implementations.

FIG. 2D illustrates method 200, in accordance with one or more implementations.

An operation 218 may include applying a hash function to the encrypted first set of data points to generate a hash of the encrypted first set of data points. Operation 218 may be performed by one or more hardware processors configured by machine-readable instructions including a module that is the same as or similar to hash module 124, in accordance with one or more implementations.

An operation 220 may include applying a checksum function to the hash of the encrypted first set of data points to verify the integrity of the encrypted first set of data points. Operation 220 may be performed by one or more hardware processors configured by machine-readable instructions including a module that is the same as or similar to checksum module 126, in accordance with one or more implementations.

FIG. 2E illustrates method 200, in accordance with one or more implementations.

An operation 222 may include applying a hash function to the first set of data points to generate a hash of the first set of data points. Operation 222 may be performed by one or more hardware processors configured by machine-readable instructions including a module that is the same as or similar to hash module 124, in accordance with one or more implementations.

An operation 224 may include applying a checksum function to the hash of the first set of data points to verify the integrity of the first set of data points. Operation 224 may be performed by one or more hardware processors configured by machine-readable instructions including a module that is the same as or similar to checksum module 126, in accordance with one or more implementations.

In order to further illustrate the present disclosure, a non-limiting example implementation is described below.

Assume that the item of input data D consists of plain text words with a fixed bit length such as 32 or 64 bits. The present disclosure envisages anonymising and securing this input data item by encrypting it using a plurality of unique one-time-pads, storing the one-time-pads at different locations and splitting the encrypted data into shards storing each shard at a different location as well.

Thus, the input data item D is a sequence of words with a fixed length of b bits and that we want to store the input data item D in d different, geographically separated data centres.

First, a random number generator (for example a hardware random number generator (HRNG), a true random number generator (TRN), a cryptographically secure pseudorandom number generator (CSPRNG), a quantum random number generator using shot noise, nuclear decay and so on, or a classical random number generator using thermic noise or atmospheric noise and so on) of the one-time-pad generating module described above is initialised. The CSPRNG will be used to generate sequences of random or pseudorandom words of length b matching the length of input data item D.

Second, the CSPRNG is used to generate d-1 of such sequences. To increase security, this may be done “on the fly” i.e. in real time as and when such sequences required to avoid such sequences being unnecessarily stored in advance of when they are required. Each of the d-1 sequences of words are to act as one-time-pads to be stored separately at the d data centres.

Third, the input data item D is encrypted using each of the d-1 one-time-pads in turn.

That is, to generate the cipher text eⁱ, the input data item D is combined in turn with each of the d-1 one-time-pads using, for example, an exclusive (XOR) operation:

$${e}^{i} = {D}^{i} ⊕ {d}_{0}^{i} ⊕ {d}_{1}^{i} ⊕ … ⊕ {d}_{n - 2}^{i} \qquad ( 1 )$$

Where d₀ⁱ . . . dₙ₋₂ⁱ are the (randomly or pseudo randomly generated) words at position i of the word sequences 0 to d-2 generated by the CSPRNG, Dⁱ is the word at position i of the actual input data item D and ⊕ is the operator indicating an “exclusive or” (XOR) operation.

Alternatively, the b bit words may be unsigned integers encoded in two's complement or 2th-complement (i.e. as may be provided on known modern computer architectures) whereby the operation used is subtraction modulo 2ⁿ instead of bit-wise ⊕. Or indeed, any linear operation over any field may be used.

Thus, in an illustrative example, assume we want to store the 8-bit word D=0010 1010 securely in four data centres d₀ . . . d₃. The CSPRNG initialises and generates d-1 random or pseudorandom sequences to be stored at an associated first three of the data centres d₀ . . . d₂ for example:
d₀=0011 0101
d₁=1111 0100
d₂=0011 0101

These three generated sequences each act as a unique one-time-pad used to encrypt the input data item according to equation (1). Thus, the 8-bit word D=0010 1010 is encrypted in three corresponding sequential steps using the non-limiting, exemplary XOR operation to generate the sequence stored at the final data centre d₃:

$$\frac{\begin{matrix}0010 \; 1010 ( = D ) \\ ⊕ 0011 \; 0101 ( = {d}_{0} )\end{matrix}}{0001 \; 1111}$$

$$\frac{⊕ 1111 \; 0100 ( = {d}_{1} )}{1110 \; 1011}$$

$$\frac{⊕ 0011 \; 0101 ( = {d}_{2} )}{1110 \; 1011 ( = {d}_{3} )}$$

Accordingly, d₃ corresponds to cipher text eⁱ that is the encrypted input data item D.

In this way, four sets of data points or sequences (also described herein as data shards) of equal length, in this case 8 bits, are generated whereby 3 of the 4 are the one-time-pads and 1 of the 4 is the output cipher text.

Each is stored in a different location, for example in one or more servers of four geographically separated data centres d₀ . . . d₃ such that even if an attacker has control of 3 of the 4 data centres and thus has control of 3 of the 4 of data centres d₀ . . . d₃ he is still unable to reconstruct the original input data.

The intermediate values computed between each of the XOR steps (i.e. 0001 1111 and 1110 1011) are not stored in any of the data centres as these would be vulnerable to attack by an attacker with access to only a single one or two of the one-time-pads, for example access to the single one-time-pad stored at data centre d₀ and/or that stored at data centre d₁.

Restoring the input data item D requires control of 4 of the 4 datacentres d₀ . . . d₃ so that the XOR (or, if the above described subtraction modulo 2ⁿ method was used, addition modulo 2ⁿ) operation may be performed again to obtain:

$$\frac{\begin{matrix}1101 \; 1110 ( = {d}_{3} ) \\ ⊕ 0011 \; 0101 ( = {d}_{2} )\end{matrix}}{1110 \; 1011}$$

$$\frac{⊕ 1111 \; 0100 ( = {d}_{1} )}{0001 \; 1111}$$

$$\frac{⊕ 0011 \; 0101 ( = {d}_{0} )}{0010 \; 1010 ( = D )}$$

Accordingly, the above described process is secure against an attacker that has control over d-1 out of d data centres i.e. an attacker that is able to obtain n-1 data shards out of the n generated data shards. This is because an attacker possessing up to n-1 out of n data shards still has to attack at least one perfect one-time-pad.

It will be appreciated that the XOR operation is commutative and associative, that is:

### Commutativity:

$$∀ x , y . x ⊕ y = y ⊕ x$$

### Associativity:

$$∀ x , y , z . ( x ⊕ y ) ⊕ z = y ⊕ ( x ⊕ z )$$

Accordingly, from these properties, we know that any order in which equation (1) is computed will yield the same result.

For example:

$${D}^{i} ⊕ {d}_{0}^{i} ⊕ {d}_{1}^{i} ⊕ … ⊕ {d}_{n - 2}^{i} = {d}_{0}^{i} ⊕ {d}_{1}^{i} ⊕ … ⊕ {d}_{n - 2}^{i} ⊕ {D}^{i}$$

The same applies where the addition and/or subtraction modulo 2ⁿ operation is applied:

$$∀ x , y , n . x + y ≡ y + x ( mod {2}^{n} )$$

$$∀ x , y , z , n . ( x + y ) + z ≡ y + ( x + z ) ( mod {2}^{n} )$$

It will also be appreciated that both XOR and the addition and/or subtraction modulo 2ⁿ operation are linear operators over their respective rings (i.e. B for the XOR operator and Z/2n for the addition and/or subtraction modulo 2ⁿ).

These properties accordingly allow the above described sequential encryption by a plurality of unique one-time-pads to be used to secure and anonymise the input data item D and spread the risk of its storage across a plurality of different locations, while at the same time allowing the encrypted data to be restored by only those with control over the cipher text and all of the one-time-pads.

In the context of one-time-pads and the concept perfect secrecy, it will further be appreciated that:

$$c = m ⊕ k$$

Where m is the plain text input data item, k is the secret key and c is the cipher text. The cipher text can be decrypted using:

$$c ⊕ k = ( m ⊕ k ) ⊕ k = m ⊕ ( k ⊕ k ) = m ⊕ 0 = m$$

If the key k is truly random (i.e. uniformly distributed and independent of the cipher text) and never re-used, one-time pads are information-theoretically secure, i.e., the encrypted message (i.e. the cipher text) does not provide any information about the original message.

In general terms, perfect secrecy provided by a one-time-pad is immune to brute force attacks, as trying all possible keys will yield all possible plain text sequences with the same likelihood such that the attacker is given no information about what the actual plain text input was. This property also does not change under the presence of a sufficiently large and precise quantum computer. This is because, whilst a quantum computer may decrease significantly the time taken to calculate all possible plain text sequences, it still would provide no information about which is the correct one.

Three specific examples are now provided to demonstrate how a method according to the present disclosure remains secure against an attacker who has control over n-1 of the n shards. The term stream or data stream used herein refers to, for example, bit streams corresponding to input data item D described above.

### Example 1

The attacker has control over n-1 shards storing the random data streams of plain text (Dⁱ). In terms of equation (1), the attacker is able to compute:

$${k}^{i} = {d}_{0}^{i} ⊕ {d}_{1}^{i} ⊕ … ⊕ {d}_{n - 2}^{i}$$

As the d₀ⁱ . . . dₙ₋₂ⁱ are uniformly distributed and independent of the plain text (Dⁱ), the kⁱ are also uniformly distributed and independent of the plain text (Dⁱ). Thus, the attacker has not learned anything about the plain text (Dⁱ).

Conceptually, this situation is identical to an attacker that has obtained a copy of one perfect one-time-pad but has neither control over the cipher text nor the plain text (Dⁱ).

### Example 2

The attacker has control over n-2 shards storing the random data streams of plain text (Dⁱ) as well as the shard storing the cipher text eⁱ.

Without loss of generality, we accordingly assume that the attacker has control over eⁱ and d₁ⁱ . . . dₙ₋₂ⁱ. Thus the attacker is able to compute:

$${k}^{i} = {d}_{1}^{i} ⊕ … ⊕ {d}_{n - 2}^{i}$$

To obtain the plain text (Dⁱ), the attacker needs to compute:

$${D}^{i} = {e}^{i} ⊕ {d}_{0}^{i} ⊕ {k}^{i}$$

As d₁ⁱ . . . dₙ₋₂ⁱ are uniformly distributed independent plain text (Dⁱ), the kⁱ are also uniformly distributed and independent of the plain text (Dⁱ). Thus to obtain the plain text, the attacker would need to obtain the result of computing:

$${e}^{i} ⊕ {d}_{0}^{i}$$

As the attacker does not know the value of d₀ⁱ, this is as hard as attacking a one-time pad i.e. all possible values of d₀ⁱ are equally likely.

Conceptually, the situation is identical to an attacker that has obtained the cipher text of a perfect one-time pad but neither has control over the key nor the plain text.

Note that whilst the XOR operation is used in the examples above, the property of linearity in any field applies to other operations as well. Thus, the same proof and examples hold when replacing the XOR with addition/subtraction modulo 2ⁿ implemented in many CPU architectures as machine integers encoded in two's complement. It is accordingly envisaged that any linear function may be used to encrypt the first set of data points n times using the n one-time-pads.

As will be appreciated, as long as the random or pseudorandom data sets generated by the CSRNG are truly random or pseudorandom and are not re-used, the original input data can only be obtained by knowing all n data sets. An attacker knowing n-1 of the data sets is not able to recover the original data as all bit streams of the same length as the input data have the same likelihood of being the original input data.

It is envisaged that security may further be improved by pre-processing the input data using, for example, an authenticated encryption scheme such as an AES256 encryption scheme. This pre-encrypted data may then be used as the input data instead of the unencrypted data string. Thus, even if an attacker does somehow obtain control over all n data sets, he is still faced with the task of cracking the AES256 encryption scheme. Alternatively, if the attacker obtains the AES256 key he would still need to obtain control over all n data sets stored at the n different data centres.

In implementing the above described methods, additional operations may be performed to check the integrity of the data.

For example, in order to ensure integrity of the data shards, checksums may be performed periodically and inserted into the data streams. There are two ways to this.

In a “shard then hash” approach, a hash is computed each encrypted data shard. This has the advantage that, during the restoration of the encrypted data, it is possible to check the integrity of the data before starting the restore process as checksumming the hash of the encrypted data shard will validate the integrity of the data shard. This does however increase the computational overhead for computing the hash function as a separate hash is required for each data shard. Thus, the “shard then hash” approach provides a means to check data shard integrity, integrity of the plaintext input data. The generated hash should however not reveal any information about the plain text input data as the data for each shard must appear to be random. The generated hash included in the data streams must accordingly also appear to be random.

Alternatively, in a “hash then shard” approach, the hash of the plain text input data is generated and added to the data stream before it is encrypted and sharded. This saves some computational overhead as only a single hash needs to be generated. However, disadvantageously, it is not possible to validate the integrity of each data shard until the original plain text has been decrypted. This approach thus provides plain text integrity only. A possible risk of this approach is that an attacker may send a fake data shard and this would not be possible to detect until the hashes of the decrypted plain text are checksummed. As above, the hash should appear to be random to avoid revealing any information about the plain text input data.

Alternatively or additionally, instead of performing a simple hash on a chunk of the input data or the data shards, the hash may be provided as a message authentication code (MAC) as part of a MAC scheme. In this way, the integrity of the input data may not only be validated but its authenticity may also be validated to prevent attacks where data is maliciously changed without authentication.

Further, in implementing the above methods on arbitrarily large input data files with minimal memory requirements, the method may be implemented using data streams. That is, the input data file needs to be buffered and chunked (as byte by byte processing would otherwise incur significant memory and processing overheads). It is also envisaged that the chunks of the chunked input data file are also the same size as the chunks on which the above described hashes and checksums are computed as this provides logical efficiency. It will be appreciated that the specific size of each chunk will be determined by performance analysis and an appropriate chunk size may be chosen according to system requirements and hardware availability. For example, there will be a performance overhead incurred per chunk but also overly large chunks will lead to high memory utilisation.

It is also envisaged that, to further improve security, the above described methods may be performed repeatedly at regular or irregular intervals so that even if an attacker begins to obtain control of some n one-time-pads, they will only have a limited amount of available time to obtain access to all the other one-time-pads until the input data is re-encrypted and they will have to start again. Such a method also finds use in the event of a known compromise by an attacker (through accidental or intentional release of information) of one or more of the data shards. By re-performing the above encryption and data sharding method, the compromised data shard or shards are invalidated. It is envisaged that this re-performing comprises three steps:
(i) retrieve the data shards and restore the input data file;
(ii) check that the checksum of the retrieved data shards and/or the restored input data file matches the previously generated one stored;
(iii) re-encrypt the input data file and re-shard it by storing the n one-time-pads at the plurality of different locations.

It will be appreciated that if a location is known to be compromised, appropriate measures are to be taken to avoid sending a data shard to such a location to avoid the data shard becoming immediately re-compromised.

Example pseudocode of the encrypting and data sharding, and restoring methods is provided below:

```
func SecretSharingCluster(input [ ]byte) ([ ]byte, [ ]byte,
[ ]byte, [ ]byte, error) {
    s1 := make([ ]byte, len(input))
    s2 := make([ ]byte, len(input))
    s3 := make([ ]byte, len(input))
    s4 := make([ ]byte, len(input))
    −, err := rand.Read(s1)
    if err != nil {
        return nil, nil, nil, nil, err
    }
    −, err = rand.Read(s2)
    if err != nil {
        return nil, nil, nil, nil, err
    }
    −, err = rand.Read(s3)
    if err != nil {
        return nil, nil, nil, nil, err
    }
      for i := 0; i < len(s4); i++ {
          //XOR
          //s4[i] = ((input[i] − s1[i]) − s2[i]) − s3[i]
          //modulo − utilises inherent overflow mechanic
          to achieve modulo
          s4[i] = input[i] − s1[i] − s2[i] − s3[i]
      }
      return s1, s2, s3, s4, nil
  }
  func SecretSharingRestore(s1, s2, s3, s4 [ ]byte) [ ]byte {
      output := make([ ]byte, len(s1))
      for i := 0; i < len(output); i++ {
          //XOR
          //output[i] = ((s4[i] − s3[i]) − s2[i]) − s1[i]
          //modulo − utilises inherent overflow mechanic
          to achieve modulo
          output[i] = s1[i] + s2[i] + s3[i] + s4[i]
      }
      return output
  }
```

It will further be appreciated that performance improvements of the above described methods may be achieved by providing each data centre with buffer management store to functionality to actively manage the chunking and buffering of the input data streams.

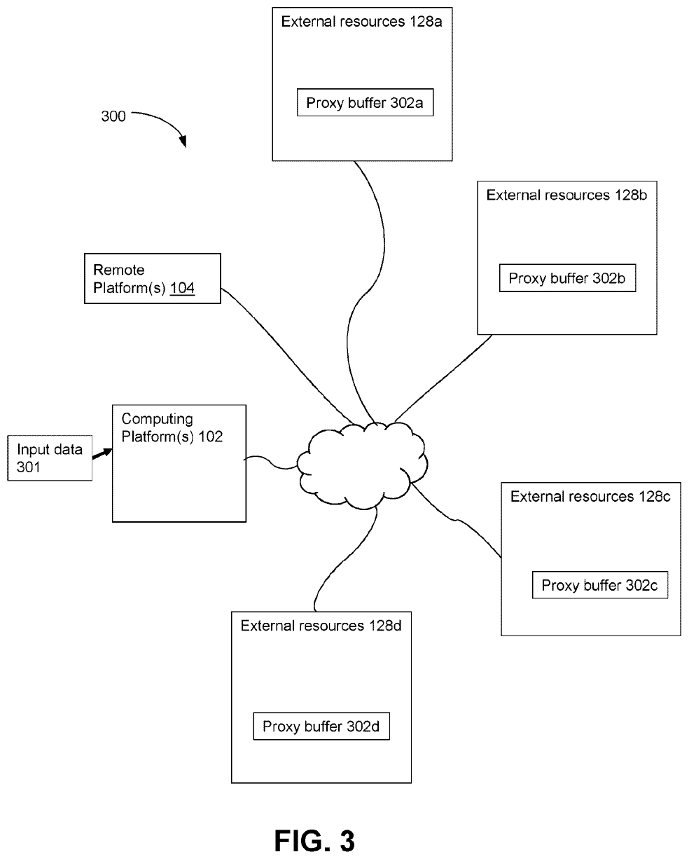

FIG. 3 illustrates a system 300 configured for securely storing an anonymised input data item, in accordance with one or more implementations illustrating buffer management store configurations. Like reference numerals refer to like-numbered features in FIGS. 1 and 2A-2E. The details of computing platform(s) 102, remote platform(s) 104 are not repeated but are envisaged to be as provided in for example FIG. 1.

As in FIG. 1, input data 301 is received as a data stream by computing platform 102 where the above described encrypting method is applied. In this case, the plurality of different locations or data stores where the n one-time-pads and cipher texts of the input data stream are stored are represented by a plurality of external resources 128a, 128b, 128c, 128d. Whilst only four such resources are shown, it is envisaged that any number may be provided. Each may be provided with its own dedicated buffer management store solution (not shown) configured to actively manage the chunking and buffering of the data. Alternatively, as is shown in FIG. 3, each may instead be provided with a proxy buffer layer 302a, 302b, 302c, 302d to provide such functionality.

In the case of a dedicated buffer management store (not shown), this may advantageously replace a third-party provider data centre's own back end to thereby enable the building of a database specific buffer able to dynamically increase or decrease based on query demand, as well as enable application specific database transport protocols to be used to optimise or minimise communication volume (i.e. data block size) and round trip time to increase performance of the system.

In the case of a proxy buffer layer 302a, 302b, 302c, 302d, these may also mitigate any performance constraints of third-party provider data centre back ends (for example which often have database buffer limits of 4 kb) by similarly providing a dynamic, scalable buffer size and which enable application specific database transport protocols to be used

In both cases, the computer platform(s) may accordingly be provided with an indexer to index columns and/or rows of data of the data stream and a cache memory to further reduce communication volume and/or reduce round trip time.

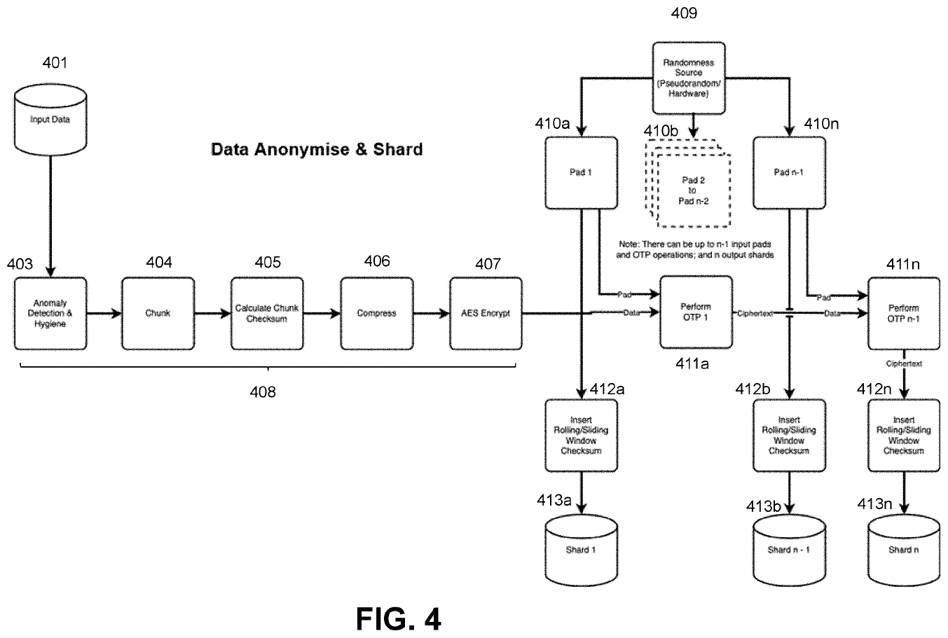

FIG. 4 illustratively shows a flowchart illustrating steps of a method according to the present disclosure. The steps represent an exemplary implementation only and it will be appreciated that other steps are also envisaged.

In a first step, input data 401 is input into the system. The input data 401 may a standalone data item or a continuous stream of data. Anomaly detection and data cleaning is performed on the input data to filter out any corrupted or inauthentic data, for example data that was included in the input data in error. The cleaned input data is chunked 404 and the integrity of the chunking process is checked, for example using a checksum operation 405. The chunk is compressed and optionally encrypted according to a predetermined encoding protocol, for example an AES encryption protocol. These steps together comprise the pre-processing steps which are performed on the input data 401. It is envisaged that each chunk may be sent to a different location to perform steps 405, 406, 407 thereon immediately after chunking. Alternatively, the entire pre-processing 408 may be performed at a single location and only sent to separate locations for sharding after being compressed and encrypted in steps 406 and 407. The encryption in this step is optional rather than mandatory as the purpose of the pre-processing is primarily to provide data integrity and authenticity rather than full security (which is instead provided in the subsequent sharding process). Thus the optional encrypting during the pre-processing step is effectively an optional additional layer of security.

With the pre-processed chunks prepared, sharding may occur. Unique, independent sources of randomness or pseudorandomness generate n one-time-pads 410a, 410b, 410n for each chunk to be encrypted. That is, steps 409-413n are performed separately and uniquely for each chunk of data. With the one-time-pads 410a, 410b, 410n prepared, the chunks are encrypted 411a, 411n as described above resulting in a plurality of data shards. A rolling/sliding window checksum 412a, 412b, 412n may be performed on each shard as it is being generated to ensure data integrity and finally each shard is stored at a different location 413a, 413b, 413n.

Given that steps 409-413n are performed for each chunk, and not just for each input data item, security of each chunk is guaranteed, facilitating efficient and highly secure distributed storage of data in an anonymous manner.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation. For example, as the input data that is to be protected is envisaged to be a stream of binary data chunked into a predetermined bit-length, it is not necessary to pre-process the input data in any way, allowing the method of the present disclosure to be input agnostic. This is advantageous over systems that rely on, for example, k-means clustering and the structure of the input data to guarantee security as pre-processing the input data can be cumbersome.

For example, as has been described above, the use of the above described XOR operations and/or bit-wise modular additions are computationally cheap to implement in hardware, thereby providing substantial reductions in computational resource requirements to run the method of the present disclosure compared to any method that uses less efficient operations.

For example, the term chunk as used herein may refer to sections of a larger block of input data that can be managed, stored and/or transmitted separately more efficiently than the same operations performed on the entire body of data from which they are split.

1. A computer implemented method of securely storing an anonymised input data item, the method comprising:
(i) obtaining a first set of data points defining a representation of the input data item, wherein each data point is defined by a numeric value;
(ii) generating a plurality n of independently random or pseudorandom second sets of data points, each set comprising a one-time-pad, where n is two or more,
(iii) encrypting the first set of data points n times, each time using one of the n one-time-pads and
(iv) storing each of the n one-time-pads and the encrypted first set of data points at respective different locations.

2. The method of claim 1, wherein the first set of data points and each of the second sets of data points has the same bit length.

3. The method of claim 1, wherein the different locations comprise geographically separated data centres and wherein said storing comprises storing the n one-time-pads on one or more servers at the geographically separated data centres.

4. The method of claim 1, wherein each of the n one-time-pads and the encrypted first set of data points are stored in said respective different locations without being further encrypted.

5. The method of claim 1, comprising encoding the input data item according to a predetermined encoding protocol to generate said representation of the input data item.

6. The method of claim 5, comprising splitting the input data item into a plurality of chunks before performing said encoding on each of said chunks.

7. The method of claim 6, comprising performing said encoding on each chunk and said encrypting at respective different locations.

8. The method of claim 6, wherein said splitting comprises generating an index comprising an identifier for each chunk, and wherein the method comprises recording respective storage locations of the n one-time-pads and the encrypted first set of data points generated with each said chunk, and associating the recorded storage locations with a respective identifier of the index.

9. The method of claim 8, comprising storing the index at a storage location separate to the storage locations at which the n one-time-pads and the encrypted first set of data points are stored.

10. The method of claim 6, wherein said splitting comprises setting a chunk size based on one or more of: (i) a past retrieval rate of the input data item, or (ii) a size of the input data item.

11. The method of claim 1, wherein said encrypting comprises applying a linear function to the first set of data points using the n one-time-pads.

12. (canceled)

13. (canceled)

14. The method of claim 1, comprising at predetermined intervals:
retrieving from the plurality of different locations the n one-time-pads and the encrypted first set of data points,
decrypting the encrypted first set of data points n times using the n one time pads; and
performing steps (i)-(iv) to re-encrypt the first set of data points.

15. The method of claim 1, comprising entropy scanning the encrypted first set of data points.

16. The method of claim 15, wherein said entropy scanning is performed before storing the n one-time-pads and the encrypted first set of data points at the respective different locations.

17. The method of claim 1, comprising applying a hash function to the encrypted first set of data points to generate a hash of the encrypted first set of data points; and
applying a checksum function to the hash of the encrypted first set of data points to verify the integrity of the encrypted first set of data points.

18. The method of claim 1, comprising applying a hash function to the first set of data points to generate a hash of the first set of data points; and
applying a checksum function to the hash of the first set of data points to verify the integrity of the first set of data points.

19. (canceled)

20. The method of claim 1, wherein the first set of data points comprises a numerical representation of a sequence of words and wherein the encrypted first set of data points comprises a cipher text.

21. A computer implemented method of recovering a securely stored anonymised data item, wherein the data item is represented by a first set of data points encrypted with n one-time-pads, each one-time-pad comprising a plurality n of random or pseudorandom second sets of data points, each data point defined by a numeric value, the method comprising:
retrieving from a plurality of different locations the n one-time-pads and the encrypted first set of data points; and
decrypting the encrypted first set of data points n times using the n one time pads.

22. (canceled)

23. A computer program comprising instructions which, when executed by the computer, cause the computer to carry out the method of claim 1.

24. A database management system for securely storing an anonymised data item, the system comprising:
a plurality of data stores for storing one or more data entries;
a processing device; and
a computer-readable medium connected to the processing device configured to store instructions that, when executed by the processing device, performs the operations of:
(i) obtaining a first set of data points defining a representation of the input data item, wherein each data point is defined by a numeric value;
(ii) generating a plurality n of independently random or pseudorandom second sets of data points, each set comprising a one-time-pad, where n is two or more,
(iii) encrypting the first set of data points n times, each time using one of the n one-time-pads; and
(iv) storing each of the n one-time-pads and the encrypted first set of data points at a respective one of the plurality of data stores.

25. (canceled)

26. (canceled)

27. (canceled)
